(19) United States
(12) Patent Application Publication
(10) Pub. No.: US 2007/0064271 A1
(43) Pub. Date: Mar. 22, 2007

(54) IMAGE PROCESSING APPARATUS AND METHOD THEREOF

(76) Inventor: Woo-jun CHUNG, Suwon-si (KR)

Correspondence Address: STANZIONE & KIM, LLP, 919 18TH STREET, N.W., SUITE 440, WASHINGTON, DC, 20006, US

(21) Appl. No.: 11/468,072

(22) Filed: Aug. 29, 2006

(30) Foreign Application Priority Data
Sep. 20, 2005 (KR) 2005-87252

(51) Int. Cl. H04N 1/405

(52) U.S. Cl. 358/3.09; 358/448

(57) ABSTRACT

An image processing method and apparatus using the same. The method includes converting a continuous-tone color image into a plurality of intermediate images corresponding to a plurality of colors, dividing a first intermediate image among the plurality of intermediate images into a plurality of first screen cells of which a size and a shape are uniform in correspondence with a plurality of unit print areas, and performing half-toning on a first intermediate image, and dividing a second intermediate image among the plurality of intermediate images into a plurality of second screen cells of which the size and the shape are non-uniform and are not in correspondence with the plurality of the unit print areas, and performing the half-toning on the second intermediate image. Thus, printing can be performed at a fast speed with optimal picture quality.

### CROSS-REFERENCE TO RELATED APPLICATIONS

This application claims the benefit of Korean Patent Application No. 2005-0087252, filed on Sep. 20, 2005, in the Korean Intellectual Property Office, the disclosure of which is incorporated herein by reference in its entirety.

### BACKGROUND OF THE INVENTION

1. Field of the Invention

The present general inventive concept relates to an image processing apparatus and an image processing method, and more particularly, to an image processing apparatus and an image processing method to process image data in order to perform printing at a fast speed with an optimum picture quality.

2. Description of the Related Art

An image processing apparatus, such as a computer system, performs image processing of original images including characters, photographs, pictures, etc., so that a printing device, such as a printer and a multi-functional peripheral device can perform printing of the original images on recording media, such as sheets of paper. The printing device sprays and sets down ink, toner, etc., on the recording medium based on image-processed printing data, and forms a plurality of dots corresponding to the original images on the recording medium. The image processing apparatus converts a continuous-tone original image into a half-tone image, which is an image that can be practically printed using various combinations of dots to represent different portions of the continuous-tone original image. A process called “half-toning” is used by the printing device to determine which area of the recording medium is to have the dots formed by spraying or setting down ink, toner, etc. thereon. When using the half-toning process, various gray levels (shades of gray) or color levels of the original images can be expressed as an amplitude, a frequency, a density, etc., of dots at a predetermined area of a half-tone image.

The half-toning process can be classified as one of a screening method of modulating the amplitude of a dot (i.e., an amplitude modulation (AM) method); an error diffusion method of modulating the frequency of a dot (i.e., a frequency modulation (FM) method); an iterative method, etc. An ordered screen and a stochastic screen can be used for the screening method and the error diffusion method. The screen, that is, the AM ordered screen which is used for the screening method is classified as either a rational screen or an irrational screen. FIGS. 1A, 1B, 2A, and 2B are diagrams illustrating a rational screen and an irrational screen.

As illustrated in FIGS. 1A and 1B, a plurality of pixels which a printing apparatus can express is illustrated in a grid 10. A rational screen 11 and an irrational screen 21 which overlapped over the grid 10 are illustrated in FIGS. 1A and 1B, respectively. The rational screen 11 and the irrational screen 21 comprise a plurality of screen cells 11a and 21a, respectively. The screen cells 11a and 21a of the rational screen 11 and the irrational screen 21, respectively, intersect at intersection points 11b and 21b. The half-toning process is applied to the original image in units corresponding to the screen cell 11a and 21a. When using the AM method, the amplitude of a dot (not illustrated) to be formed in the screen cell 11a or 21a represents a gray level or color level of the original image corresponding to the screen cell 11a or 21a. When the amplitude of the dot in the screen cell 11a or 21a is determined based on printing data of the original image, the ink (or the like) is applied to a pixel corresponding to each dot in the grid 10.

On one hand, the rational screen 11 has a feature that all intersection points 21b of the screen cells 11a always coincide with those between the respective pixels in the grid 10. On the other hand, the irrational screen 21 has a feature that all intersection points 21b of the screen cell 21a do not always coincide with those between the respective pixels in the grid 10. The features of the rational screen 11 and the irrational screen 21 are compared with each other in the following Table.

TABLE 1

| | Rational Screen | Irrational Screen |
|---|---|---|
| Dot center | Always integer grids | Not always integer grids |
| point | | |
| Screen cell | Rational tangent | Irrational tangent |
| | Both the size and the | Both the size and the |
| | shape of the screen | size of the screen |
| | cell are uniform | cell are not uniform |
| | | cell are not same. |
| LPI (line per | Limited | Free |
| inch)/Angle | | |
| Moire | Large number of | Small number of |
| | inter-screen moires | inter-screen moires |
| | occur. | occur. |
| Size of files | Small | Large |

As shown in Table 1, in case of the rational screen 11, a dot center point can always be positioned at grids of an integer number. However, this is not the case in the irrational screen 21. Moreover, in the rational screen 11, both the size and shape of the screen cell 11a are uniform, however, the size and shape of the screen cells 21a of the irrational screen 21 are not uniform. The sizes and shapes of the screen cells 11a and 21a in the rational screen 11 and the irrational screen 21 are compared in FIGS. 2A and 2B, respectively. For explanation purposes, each pixel corresponding to the respective screen cell 11a and 21a in the grid 10 has not been individually illustrated. As illustrated in FIG. 2A, in the rational screen 11, all intersection points 11b in the screen cells 11a always coincide with those between the respective pixels in the grid 10. Therefore the number and arrangement of the pixels corresponding to the respective screen cells 11a in the grid 10 are uniform. However, in the irrational screen 21, all intersection points 21b of the screen cell 21a do not always coincide with those between the respective pixels in the grid 10. Therefore the number and arrangement of the pixels corresponding to the respective screen cells 21a in the grid 10 are irregular.

Additionally, if a plurality of screen cells 11a and 21a are repetitively arranged, particularly when a screen is disposed at an angle of 0°, a phenomenon in which horizontal and vertical patterns are prominently seen occurs due to the plurality of screen cells 11a and 21a. In order to prevent this pattern phenomenon, the screen is inclined at about 45°, thereby performing a screening.

When using color half-toning, four CMYK screens of cyan (C), magenta (M), yellow (Y), and black (B) are used in one image. In order to prevent patterns, which are prominently captured by the human eye as described above, the screening is performed such that four screens corresponding to the colors of CMYK are inclined by respective predetermined angles in the color half-toning. In this case, a prominently repetitive pattern, which does not exist in an actual original image, is generated in an image which is obtained by inclining the four screens at the respective predetermined angles. This prominently repetitive pattern is referred to as a “moire.”

There are various types of moires. When two or more screens angled differently from each other are overlapped, the moire generated is called an inter-screen moire. FIGS. 3A and 3B illustrate a first screen and a second screen which are inclined at a predetermined angle, respectively, and FIG. 3C illustrates inter-screen moires generated when the first screen and the second screen are overlapped with each other.

Referring back to Table 1, a large number of inter-screen moires are generated when using the rational screen 11, and a small number of inter-screen moires are generated when using the irrational screen 21. This is due to the size and the shape of each screen cell (11a and 21a) in the respective screens (11 and 21).

As illustrated in Table 1, when using the irrational screen 21, which generates the small number of inter-screen moires, an amount of data which is required for processing an image is much larger in comparison with that of the rational screen 11. Therefore, the size of the image-processed file becomes large. If the size of the file becomes large in this manner, it is very difficult to print the original image at fast speed with optimum picture quality.

### SUMMARY OF THE INVENTION

The present general inventive concept provides an image processing apparatus and an image processing method to perform printing at a fast speed with optimum picture quality.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image processing method, comprising converting a continuous-tone color image into a plurality of intermediate images corresponding to a plurality of colors, dividing a first intermediate image among the plurality of intermediate images into a plurality of first screen cells of which a size and a shape are uniform in correspondence with a plurality of unit print areas, and performing half-toning on the first intermediate image, and dividing a second intermediate image among the plurality of intermediate images into a plurality of second screen cells of which a size and a shape are non-uniform and are not in correspondence with the plurality of the unit print areas, and performing the half-toning on the second intermediate image.

The foregoing and/or other aspects of the present general inventive concept are also achieved by providing a method of processing an image usable in a printing device, the method including separating an image into a plurality of color planes, performing a first screening process by applying at least one rational screen to at least one first color plane of the plurality of color planes, performing a second screening process by applying at least one irrational screen to at least one second color plane of the plurality of color planes, and overlapping the at least one rational screen and the at least one irrational screen on a grid to obtain an output image.

The foregoing and/or other aspects of the present general inventive concept are also achieved by providing a method of processing an image, the method including dividing image data into a plurality of components, applying an irrational screening and a rational screening to the components to produce irrational and rational screens of the image data, respectively, and combining the irrational and rational screens to obtain a halftone image.

The foregoing and/or other aspects of the present general inventive concept are also achieved by providing an image processing apparatus, comprising a color separator to convert a continuous-tone color image into a plurality of intermediate images corresponding to a plurality of colors, a first screen unit which divides a first intermediate image among the plurality of intermediate images into a plurality of first screen cells of which a size and a shape are uniform in correspondence with a plurality of unit print areas, and to perform half-toning on the first intermediate image, and a second screen unit which divides a second intermediate image among the plurality of intermediate images into a plurality of second screen cells of which a size and a shape are non-uniform and are not in correspondence with the plurality of the unit print areas, and to perform the half-toning on the second intermediate image.

The plurality of colors may comprise cyan, magenta, yellow and black. The first intermediate image may correspond to cyan and magenta, and the second intermediate image may correspond to yellow and black.

The first screen unit may perform the half-toning for the first intermediate image employing a rational screen method.

The second screen unit may perform the half-toning for the second intermediate image employing an irrational screen method.

The foregoing and/or other aspects of the present general inventive concept are also achieved by providing an image processing apparatus, including a color separator to separate an image into a plurality of color planes, a first screening unit to perform a first screening process by applying at least one rational screen to at least one first color plane of the plurality of color planes, a second screening unit to perform a second screening process by applying at least one irrational screen to at least one second color plane of the plurality of color planes, and a printing device to overlap the at least one rational screen and the at least one irrational screen on a grid to obtain an output image.

The foregoing and/or other aspects of the present general inventive concept are also achieved by providing a printing device to receive at least one irrational screen and at least one rational screen representing different components of an original image and to combine the irrational and rational screens on a grid as a halftone representation image of the original image.

The foregoing and/or other aspects of the present general inventive concept are also achieved by providing an image forming apparatus, including a printing device to print processed image data on a printing grid defined by uniform pixels, and an image processing apparatus to receive image data of an image to create a first screen cell grid having first screen cells in an arrangement that does not correspond to the uniform pixels of the printing grid from a first component plane of the received image data, to create a second screen cell grid having second screen cells in an arrangement that corresponds to the uniform pixels of the printing grid, and to overlap the first and second screen cell grids to form an output grid and provide the output grid to the printing device to print the output grid on the printing grid.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIGS. 1A, 1B, 2A and 2B are diagrams illustrating a rational screen and an irrational screen;

FIGS. 3A and 3B illustrate a first screen and a second screen which are inclined at a predetermined angle, respectively, and FIG. 3C illustrates inter-screen moires generated when the first screen and the second screen are overlapped;

FIG. 4 is a block diagram schematically illustrating an image processing apparatus according to an embodiment of the present general inventive concept;

FIG. 5 is a graphical view illustrating sizes of image files obtained by screening various types of original images to which a rational screen and an irrational screen are respectively applied;

FIG. 6 is a graphical view illustrating sizes of image files obtained by screening an original image by an image processing apparatus according to an embodiment of the present general inventive concept;

FIGS. 7A and 7B illustrate a comparison between an image obtained after screening an original image using a conventional rational screen and an image obtained from an image processing apparatus according to an embodiment of the present general inventive concept; and

FIG. 8 is a flowchart view schematically illustrating operation of an image processing apparatus according to an embodiment of the present general inventive concept.

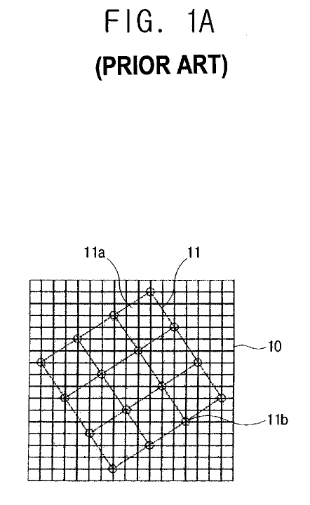

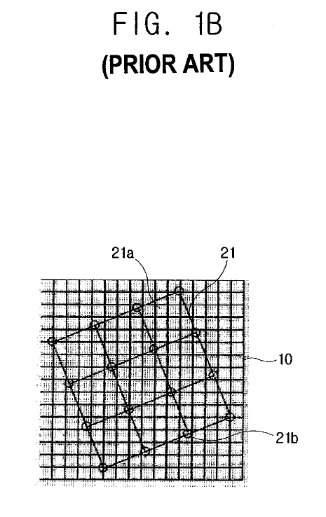

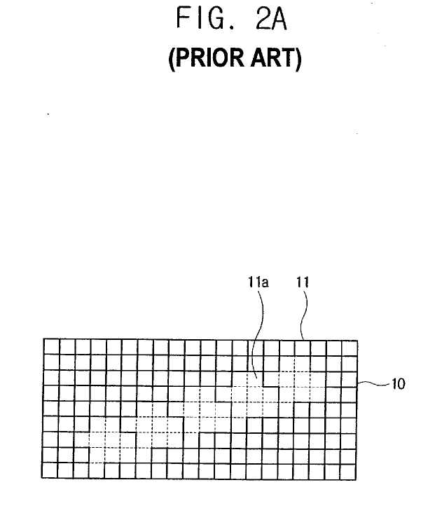

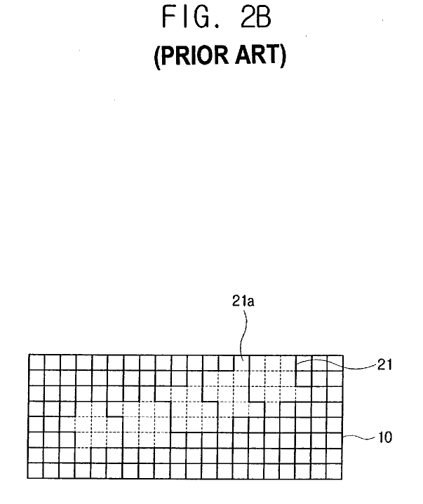

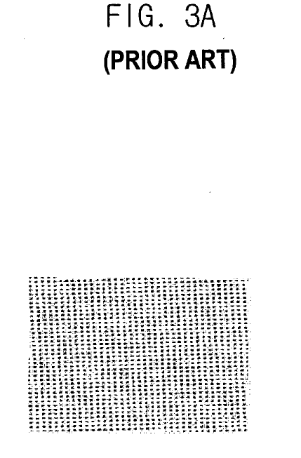

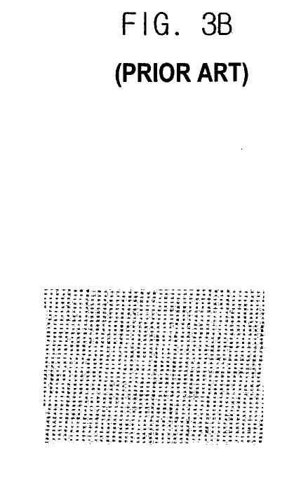

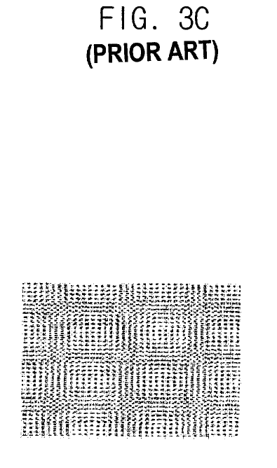

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

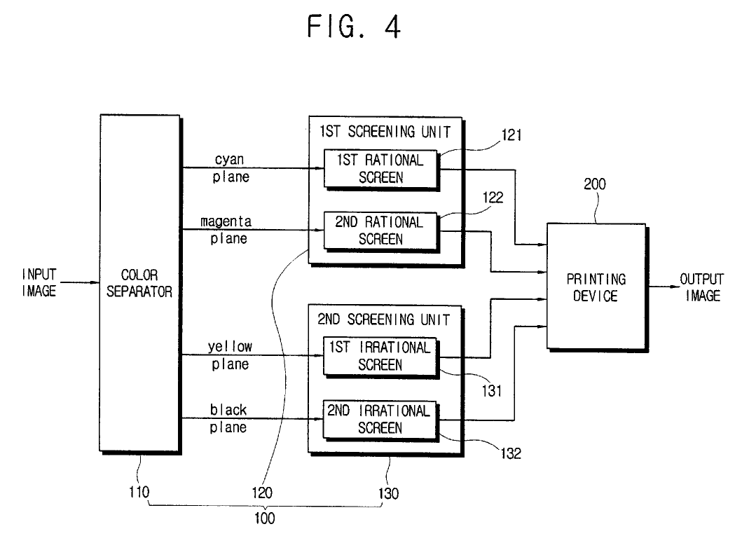

FIG. 4 is a block diagram schematically illustrating an image processing apparatus 100 according to an embodiment of the present general inventive concept. The image processing apparatus 100 performs image processing of original images including characters, photographs, pictures, etc., so that a printing device 200 can perform printing of the original images on recording media, such as sheets of paper. The printing device 200 sprays and sets down ink, toner, etc., on the recording medium based on printing data of the image-processed original image. Accordingly, the printing device 200 forms a plurality of dots corresponding to the original images on the recording medium. The printing device 200 of the present embodiment can be implemented as a printer, a multi-functional peripheral device, etc., and can form images using an ink-jet method, a laser printing method, etc.

The image processing apparatus 100 converts a continuous-tone original image into a half-tone image, which is an image that can be practically printed using various combinations of dots to represent portions of the continuous toner original image. Accordingly, the printing device can determine which area of the recording medium is to have the dots formed by spraying or setting down ink, toner, etc. thereon. In the image processing apparatus 100, various gray levels (shades of gray) or color levels of the original images can be expressed as an amplitude of dots at a predetermined area of a half-tone image. That is, according to a screening method, the image processing apparatus 100 performs half-toning to convert the original image into the half-tone image. In this case, the image processing apparatus 100 uses an AM-ordered screen, which can be largely classified as either a rational screen or an irrational screen.

The printing device 200 expresses an image as a plurality of pixels having a grid form. The rational screen and the irrational screen comprise a plurality of screen cells, respectively. The plurality of screen cells are overlapped on a grid and are applied to the original image. The image processing apparatus 100 makes the amplitude of a dot to be formed on a screen cell represent a gray level or color level of the original image within the corresponding screen cell. The printing device 200 forms the ink (or the like) on the pixel corresponding to each dot in the grid based on the printing data of the original image. The image processing apparatus 100 of the present embodiment can be implemented as a computer system, computer program, etc.

As illustrated in FIG. 4, the image processing apparatus 100 includes a color separator 110, a first screening unit 120, and a second screening unit 130. The color separator 110 converts an input color original image into a plurality of intermediate images corresponding to a color. The color separator 110 of the present embodiment separates the input color original image into four color planes showing intermediate images corresponding to cyan, magenta, yellow, and black, respectively.

The first screening unit 120 performs screening or half-toning for the intermediate images corresponding to cyan and magenta from among the four intermediate images separated in the color separator 110. The first screening unit 120 divides the intermediate image(s) (i.e., the cyan and magenta intermediate images) into a plurality of screen cells of which a size and a shape are uniform and performs screening for the plurality of screen cells. In this case, the screen cell corresponds to a plurality of pixels which the printing device 200 can express. The first screening unit 120 of the present embodiment performs the screening using a rational screen. The first screening unit 120 may include a first rational screen 121 and a second rational screen 122 corresponding to the cyan and magenta intermediate images, respectively. The plurality of pixels in the present embodiment are described as an example of a unit print area in the present general inventive concept. The intermediate image and the screen cell of the first screening unit 120 are described as an example of a first intermediate image and a first screen cell, respectively. Moreover, a method of performing the screening by using the rational screen of the first screening unit 120 according to the present embodiment is described as an example of a rational screen method.

The second screening unit 130 performs the screening or the half-toning for intermediate images corresponding to yellow and black from among the four intermediate images separated in the color separator 110. The second screening unit 130 divides the intermediate image(s) (i.e., the yellow and black intermediate images) into a plurality of screen cells of which a size and a shape are non-uniform and performs the screening for the plurality of screen cells. In this case, the screen cell corresponds to a plurality of pixels which the printing device 200 can express. The second screening unit 130 of the present embodiment performs the screening using an irrational screen. The second screening unit 130 can include a first irrational screen 131 and a second irrational screen 132 corresponding to the yellow and black intermediate images, respectively. The intermediate image and the screen cell of the second screening unit 130 in the present embodiment are described as an example of a second intermediate image and a second screen cell in the present general inventive concept, respectively. Moreover, a method of performing screening by use of the irrational screen in the second screening unit 130 of the present embodiment is described as an example of the irrational screen method. The printing device 200 receives the first and second rational screens 121 and 122 from the first screening unit 120 and the first and second irrational screens 131 and 132 from the second screening unit 130, and overlaps all the screens received from the first and second screening units 120 and 130 on the same grid to form an output image of the original image. The output image of the printing device 200 may be a halftone image of the original image. The output image may then be printed by the printing device 200.

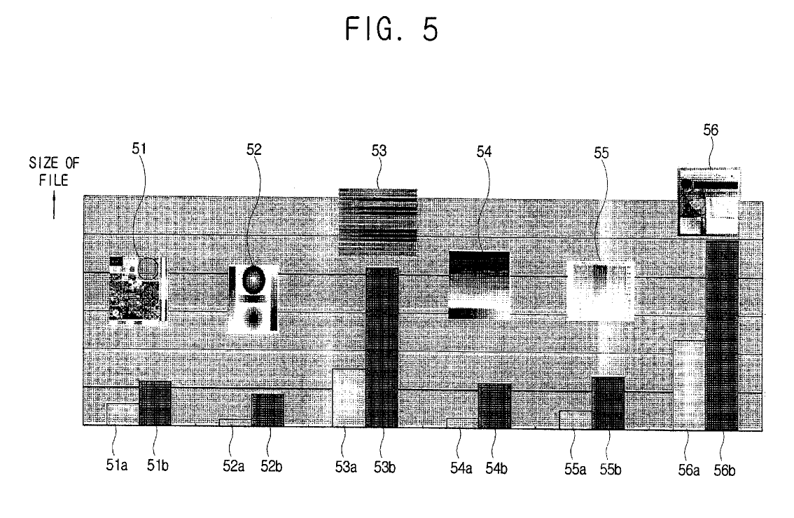

FIG. 5 is a graphical view illustrating sizes of image files obtained by performing screening of various types of original images in which a rational screen and an irrational screen are respectively applied. Reference numerals of 51 to 56 represent various types of original images. Reference numerals of 51a to 56a represent sizes of image files which are obtained when using a rational screen to perform the screening. Reference numerals 51b to 56b represent sizes of image files which are obtained when using an irrational screen to perform the screening. As illustrated in FIG. 5, the sizes 51b to 56b of the image files when applying the irrational screen are larger than the sizes 51a to 56a when applying the rational screen. Experimentally, it can be seen that an average ratio of the sizes of image files (51a to 56a and 51b to 56b) is 1:3.2, in which the rational screen and the irrational screen are applied to six samples of the original images (51 to 56).

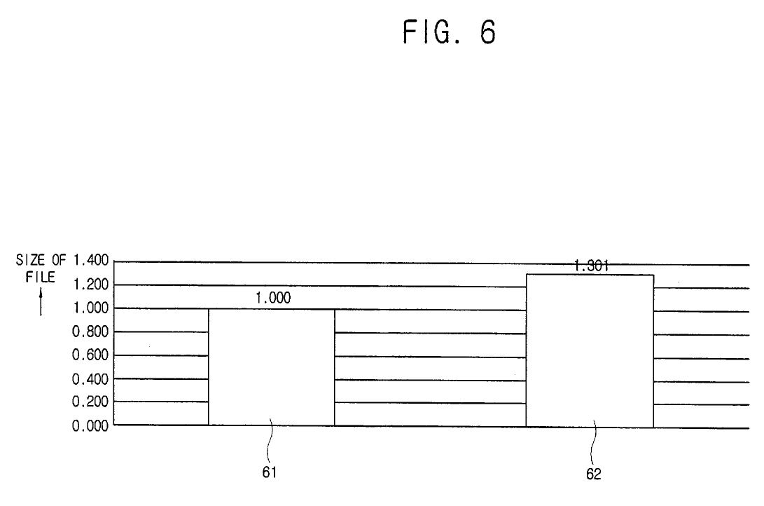

FIG. 6 is a graphical view illustrating sizes of image files obtained when screening of an original image is performed by an image processing apparatus 100 according to an embodiment of the present general inventive concept. A reference numeral 61 represents a size of an image file obtained by performing the screening using a conventional rational screen. A reference numeral 62 represents a size of an image file in which the image processing apparatus 100 performs the screening. As illustrated in FIG. 6, a difference between the size 61 of the image file when applying the conventional rational screen and the size 62 of the image file in which the image processing apparatus 100 performs screening is not particularly large. That is, the ratio of the sizes (61 to 62) is 1:1.30. As a result, when the image processing apparatus 100 of the present embodiment performs the screening, the amount of data and the time required for the image processing is nearly equal with the amount of time and data required when the screening is performing using the conventional rational screen.

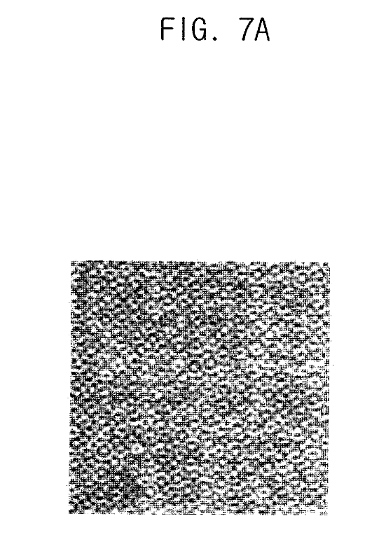

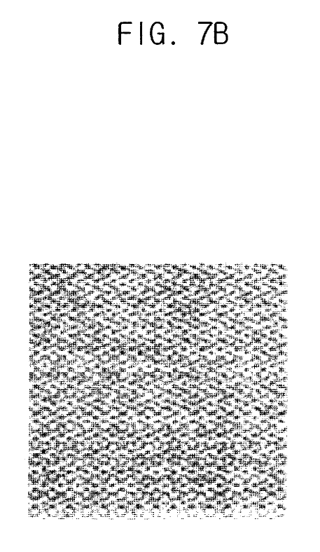

As a result, the image processing apparatus 100 of the present embodiment performs the image processing with the amount of data similar to the amount of data used when the conventional rational screen is used to perform the screening. However, a quality of the image output from the image processing apparatus 100 of is higher than the quality of the image obtained by using the conventional rational screen, since the image processing apparatus 100 uses the rational and irrational screens for different color planes. FIGS. 7A and 7B illustrate a comparison of an image which is output after applying the screening to an original image using the conventional rational screen and an image obtained from the image processing apparatus 100. As illustrated in FIGS. 7A and 7B, it can be seen that a large number of inter-screen moires show up in the image of FIG. 7A, which is output as a result of using the conventional rational screen to perform the screening. However, in comparison with the image of FIG. 7A, a small number of inter-screen moires show up in the image of FIG. 7B, which is obtained by using the image processing apparatus 100 to perform the screening.

In other words, according to the image processing apparatus 100, when an original color image is processed, a rational screen is applied to perform the screening with respect to cyan and magenta (intermediate images or color planes), and an irrational screen is applied to perform the screening with respect to yellow and black (intermediate images or color planes). In this manner, the image of the high picture quality can be obtained and the image processing can be performed at a fast speed.

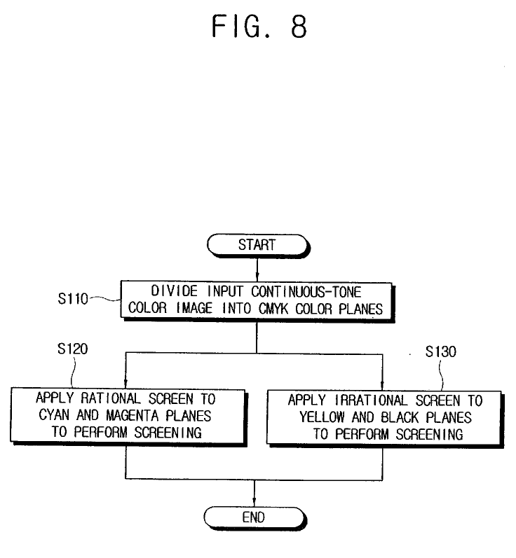

Meanwhile, FIG. 8 is a flowchart schematically illustrating a method of screening a color image according to an embodiment of the present general inventive concept. The method of FIG. 8 may be performed by the image processing apparatus 100 of FIG. 4. Accordingly, for illustration purposes, the method of FIG. 8 is described below with reference to FIG. 4. At operation S110, the image processing apparatus 100 divides an input continuous-tone color image into four color planes respectively corresponding to cyan, magenta, yellow, and black . At operation S120, the image processing apparatus 100 applies a rational screen to perform the screening with respect to the color planes corresponding to cyan and magenta. In the meantime, the image processing apparatus 100 applies an irrational screen to perform the screening with respect to the color planes corresponding to yellow and black at operation S130. The operations S120 and S130 may be performed simultaneously.

It should be understood that although a rational screen and an irrational screen are described as being applied to specific color planes, the rational screen and the irrational screen can be applied to color planes that differ from those described above with respect to FIGS. 4 and 8.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the image processing apparatus 100 may be embodied in software, hardware, or a combination thereof.

As described above, according to embodiments of the present general inventive concept, an image processing apparatus and a method thereof perform printing at fast speed with optimum picture quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image processing method, comprising:
converting a continuous-tone color image into a plurality of intermediate images corresponding to a plurality of colors;
dividing a first intermediate image among the plurality of intermediate images into a plurality of first screen cells of which a size and a shape are uniform in correspondence with a plurality of unit print areas, and performing half-toning on the first intermediate image; and
dividing a second intermediate image among the plurality of intermediate images into a plurality of second screen cells of which a size and a shape are non-uniform and are not in correspondence with the plurality of unit print areas, and performing the half-toning on the second intermediate image.

2. The image processing method as claimed in claim 1, wherein:
the plurality of colors comprises cyan, magenta, yellow and black; and
the first intermediate image corresponds to cyan and magenta and the second intermediate image corresponds to yellow and black.

3. The image processing method as claimed in claim 1, wherein the performing of the half-toning for the first intermediate image employs a rational screen method.

4. The image processing method as claimed in claim 1, wherein the performing of the half-toning for the second intermediate image employs an irrational screen method.

5. A method of processing an image usable in a printing device, the method comprising:
separating an image into a plurality of color planes;
performing a first screening process by applying at least one rational screen to at least one first color plane of the plurality of color planes;
performing a second screening process by applying at least one irrational screen to at least one second color plane of the plurality of color planes; and
overlapping the at least one rational screen and the at least one irrational screen on a grid to obtain an output image.

6. The method of claim 5, wherein the first and second screening processes are performed simultaneously.

7. The method of claim 5, wherein the performing of the first screening process comprises dividing the at least one first color plane into first screen cells that correspond to pixels that are printable by the printing device.

8. The method of claim 5, wherein the performing of the second screening process comprises dividing the at least one second color plane into second screen cells that do not correspond to pixels that are printable by the printing device.

9. A method of processing an image, the method comprising:
dividing image data into a plurality of components;
applying an irrational screening and a rational screening to the components to produce irrational and rational screens of the image data, respectively; and
combining the irrational and rational screens to obtain a halftone image.

10. An image processing apparatus, comprising:
a color separator to convert a continuous-tone color image into a plurality of intermediate images corresponding to a plurality of colors;
a first screen unit which divides a first intermediate image among the plurality of intermediate images into a plurality of first screen cells of which a size and a shape are uniform in correspondence with a plurality of unit print areas, and to perform half-toning on the first intermediate image; and
a second screen unit which divides a second intermediate image among the plurality of intermediate images into a plurality of second screen cells of which a size and a shape are non-uniform and are not in correspondence with the plurality of the unit print areas, and to perform half-toning on the second intermediate image.

11. The image processing apparatus of claim 10, wherein:
the plurality of colors comprises cyan, magenta, yellow and black; and
the first intermediate image corresponds to cyan and magenta and the second intermediate image corresponds to yellow and black.

12. The image processing apparatus of claim 10, wherein the first screen unit performs the half-toning for the first intermediate image employing a rational screen method.

13. The image processing method of claim 10, wherein the second screen unit performs the half-toning for the second intermediate image employing an irrational screen method.

14. An image processing apparatus, comprising:
a color separator to separate an image into a plurality of color planes;
a first screening unit to perform a first screening process by applying at least one rational screen to at least one first color plane of the plurality of color planes;
a second screening unit to perform a second screening process by applying at least one irrational screen to at least one second color plane of the plurality of color planes; and
a printing device to overlap the at least one rational screen and the at least one irrational screen on a grid to obtain an output image.

15. The image processing apparatus of claim 14, wherein the rational screen has uniform screen cells, and the irrational screen has non-uniform screen cells.

16. A printing device to receive at least one irrational screen and at least one rational screen representing different components of an original image and to combine the irrational and rational screens on a grid as a halftone representation image of the original image.

17. An image forming apparatus, comprising:
a printing device to print processed image data on a printing grid defined by uniform pixels; and
an image processing apparatus to receive image data of an image to create a first screen cell grid having first screen cells in an arrangement that does not correspond to the uniform pixels of the printing grid from a first component plane of the received image data, to create a second screen cell grid having second screen cells in an arrangement that corresponds to the uniform pixels of the printing grid, and to overlap the first and second screen cell grids to form an output grid and provide the output grid to the printing device to print the output grid on the printing grid.

18. The image forming apparatus of claim 17, wherein each of the first and second screen cells have one or more dots to halftone the image.

19. A computer readable medium containing executable code to perform a method of processing an image, the method comprising:
dividing image data into a plurality of components;
applying an irrational screening and a rational screening to the components to produce irrational and rational screens of the image data, respectively; and
combining the irrational and rational screens to obtain a halftone image.
